(19) United States
(12) Patent Application Publication
(10) Pub. No.: US 2025/0094305 A1
(43) Pub. Date: Mar. 20, 2025

(54) SYSTEM AND METHOD USING MACHINE LEARNING FOR ANOMALY DETECTION

(71) Applicant: Prudential Financial, Plymouth, MN (US)

(72) Inventors: Thomas C. Kennedy, Scranton, PA (US); Michael P. O'Connell, Somerville, NJ (US); Brent P. Matthews, Stevens Point, WI (US); Tyler Vitale, Parlin, NJ (US); Michael Baker, Milford, PA (US); Edward Martinez, Rockaway, NJ (US)

(73) Assignee: Prudential Financial, Plymouth, MN (US)

(21) Appl. No.: 18/888,663

(22) Filed: Sep. 18, 2024

Related U.S. Application Data
(60) Provisional application No. 63/539,023, filed on Sep. 18, 2023.

(51) Int. Cl. G06F 11/34

(52) U.S. Cl. CPC G06F 11/3419; G06F 11/3447; G06F 11/3476

(57) ABSTRACT

A computer implemented method and system for detecting one or more anomaly conditions in one or more computer devices. A Machine Learning (ML) model is trained for each of the one or more computer devices to determine threshold operating values for time-based metric data associated with each of the one or more computer devices. Utilizing the trained ML model, time-based metric data is compared for each of the one or more computer devices to the determined threshold operating values to determine if the time-based metric data falls outside of the determined threshold operating values. Provided is notification of an anomaly condition for a computer device responsive to determining the time-based metric data falls outside of the determined threshold operating values associated with the computer device.

### CROSS REFERENCE TO RELATED APPLICATIONS

This application claims priority to U.S. patent application Ser. No. 63/539,023 filed Sep. 18, 2023, which is incorporated herein by reference in its entirety.

### FIELD OF THE INVENTION

The illustrated embodiments generally relate to systems, methods and apparatuses for determining anomaly conditions in time-based data, and more particularly for using machine learning techniques to determine certain variations in time-based metric data to detect anomalies in one or more computer devices.

### BACKGROUND OF THE INVENTION

Detection of anomaly conditions in time-based metric data for networked computer devices has been a priority for computer network administrators. In various public and private computer networks, users employ devices such as desktop computers, laptop computers, tablets, smart phones, browsers, etc. to interact with others through computers and servers that are coupled to the network. Digital data, typically in the form of data packets, are passed along the network by interconnected network devices.

Anomaly events in time-based metric data (e.g., CPU metric data) on a system having aggregated components can cause harm to software hardware, or to users that make up or use the system (e.g, such as a computer system). To protect the system, system administrators seek to detect such anomaly events, for example, by searching for patterns of behavior that are abnormal or otherwise vary from an expected use pattern of particular entities, such as an organization, a group of uses, individual users, IP addresses, nodes or groups of nodes in the network, and the like. To combat such anomaly activities, system administrators can employ hardware appliances that monitor network traffic or software products, to detect anomaly conditions to mitigate any potential harmful effects.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

Generally, described herein, is a computer system, method and/or apparatus for identifying early warning indicators of significant issues associated with anomalies present in time-based metric data associated with one or more computer devices using mathematical modeling and machine learning techniques. This is particularly advantageous in that such anomaly indicators preferably enable implementation of proactive remediation to either avoid impact scenarios that often either entirely, or significantly, reduce the time required for determining root cause identification and/or resolution of IT system disruptions/issues associated with the aforesaid identified anomaly indicators.

In accordance with a purpose of the illustrated embodiments, described herein is system and method that utilizes an anomaly detection AI/ML model for reducing time to resolution for issues/problems typically caused by one or more anomalies. By leveraging advanced machine learning algorithms, the illustrated embodiments provide accurate and timely anomaly detection across diverse use cases and networked devices, which feeds into downstream business continuity and security processes. Certain features of the illustrated embodiments include time-based metric data associated with networked computer devices (e.g., servers) are modelled via an optimal fit ML model (e.g., linear, seasonal and recurrent neural network models) to detect the occurrence of one or more anomalies in the time-based metric data associated with a networked computer device. In certain embodiments, detected anomalies are grouped by device (e.g., a server), which includes determining when a count of anomalies exceeds a baseline per application for a device (e.g., a surge indication), preferably by a statistically significant value. Notification of such surge determination may then be sent to event management and notify support teams to effectuate one or more remedial actions.

In one aspect of the illustrated embodiments, described is a computer implemented method and system for detecting one or more anomaly conditions in one or more computer devices. A Machine Learning (ML) model is trained for each of the one or more computer devices to determine threshold operating values for time-based metric data associated with each of the one or more computer devices. Utilizing the trained ML model, time-based metric data is compared for each of the one or more computer devices to the determined threshold operating values to determine if the time-based metric data falls outside of the determined threshold operating values. Provided is notification of an anomaly condition for a computer device responsive to determining the time-based metric data falls outside of the determined threshold operating values associated with the computer device.

In another aspect, described is a computer implemented method and system for detecting one or more anomaly conditions in one or more computer devices each having a Central Processing Unit (CPU). A Machine Learning (ML) model is trained for each of the one or more computer devices to determine threshold operating values for a CPU for each of the one or more computer devices by applying a plurality of ML algorithmic techniques each being trained utilizing archived CPU metric data for a computer device. An error value is determined for each of the plurality of ML algorithmic techniques utilizing the archived CPU metric data for the computer device. A determination is then made as to whether a determined error value for one or more of the ML algorithmic techniques is within a prescribed threshold for use. If yes, (the error value for one or more of the ML algorithmic techniques is within a prescribed threshold for use) then the trained ML model utilizes the ML algorithmic technique having a smallest error value relative to the other applied ML algorithmic techniques as the applied trained ML model. And if no, (the error value for one or more the ML algorithmic techniques is not within a prescribed threshold for use) then a recurrent convolutional neural network (Autoencoder) is applied as the trained ML model for determining the presence of an anomaly condition in CPU metric data associated with the computer device. Utilizing the applied trained ML model, near-real time CPU metric data is compared for each of the one or more computer devices to the determined threshold operating values to determine if the near-real time CPU metric data falls outside of the determined threshold operating values. Provided is notification of an anomaly condition for a computer device responsive to determining the near-real time CPU metric data falls outside of the determined threshold operating values associated with the computer device. In certain embodiments, and responsive to utilizing the Autoencoder as the trained ML model for determining an anomaly condition for the computer device, archived CPU metric data from the computer device is applied to the recurrent convolutional neural network for training it to learn certain shapes associated with typical CPU metric data behavior associated with the computer device, such that current (e.g., near real-time) CPU metric data from the computer device is applied (input) to the trained recurrent convolutional neural network (Autoencoder) to determine if the output of the Autoencoder is sufficiently different relative to the input time-based metric data, which is indicative of an anomaly condition for the computer device. In certain embodiments, a determination is made as to whether noise associated with the input time-based metric data relative to the Autoencoder output exceeds a prescribed threshold value. In certain embodiments, the prescribed threshold values are calculated on a per computer device, per-metric-stream basis, contingent upon the statistical distributions of error when trained Autoencoders are executed with archived metric data for each CPU metric data stream for each of the one or more computer devices. In certain embodiments, further performed is grouping identified anomalies associated with a certain computer device and determining when a count value of identified grouped anomalies exceeds a prescribed value for the certain computer device, and providing notification of the identified anomaly to a user when it is determined the count value exceeds the prescribed value.

Thus, the illustrated embodiments relate to an improved computer application that performs complex AI techniques for determining variations in time-based computer network metric data for automatically detecting anomaly conditions/events in one or more networked coupled computer devices.

### BRIEF DESCRIPTION OF THE DRAWINGS

The accompanying appendices and/or drawings illustrate various, non-limiting, examples, inventive aspects in accordance with the present disclosure:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an Al server utilized with one or more of the illustrated embodiments;

FIG. 5 is a flow diagram illustrating an exemplary computer implemented method for detecting one or more anomaly conditions in one or more computer devices in accordance with the illustrated embodiments of FIGS. 1-4;

FIG. 6 illustrates application of various ML models for determining threshold operating values for a computer device in accordance with the illustrated embodiments of FIGS. 1-4;

FIG. 7 illustrates utilization of a Beta distribution in a ML model to generate confidence intervals for a computer device in accordance with the illustrated embodiments of FIGS. 1-4;

FIGS. 8A and 8B illustrates use of a convolutional recurrent neural networks (CRNNs) for determining threshold operation conditions associated for a computer device in accordance with the illustrated embodiments of FIGS. 1-4 and

FIG. 9 illustrates a dashboard type of display graphically illustrating detected anomalies in accordance with the illustrated embodiments of FIG. 1-8.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program for preferably identifying and flagging unusual data patterns, or outliers, in seasonal or variable data streams in computer devices (e.g., computer servers), for determining detection of data anomalies in such computer devices. In accordance with the illustrated embodiments, machine learning techniques are preferably utilized for modeling baseline operation of one or more computer devices, which modelling is the utilized for detecting data anomalies for enhancing operational efficiency, and minimizing risks associated with abnormal events, for the computer devices.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above.

One skilled in the art will appreciate further features and advantages of the illustrated embodiments based on the above-described embodiments. Accordingly, the illustrated embodiments are not to be limited by what has been particularly shown and described, except as indicated by the appended claims.

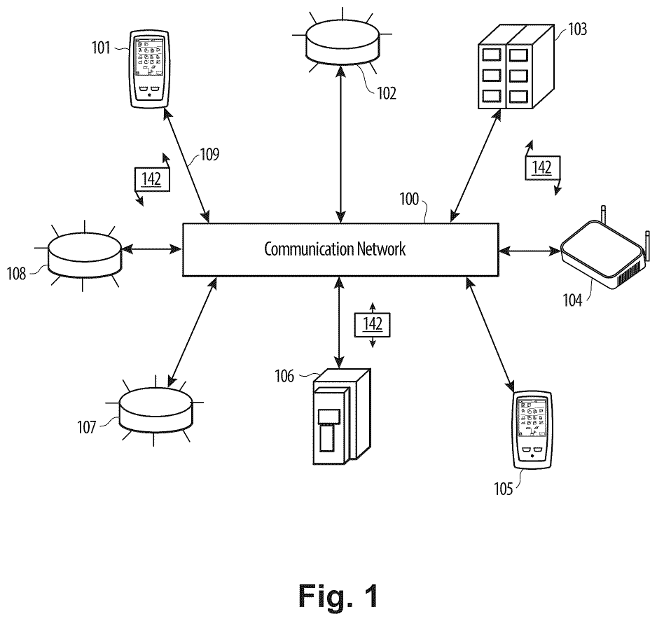

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “device”, “apparatus”, “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++, Python, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a computer device, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

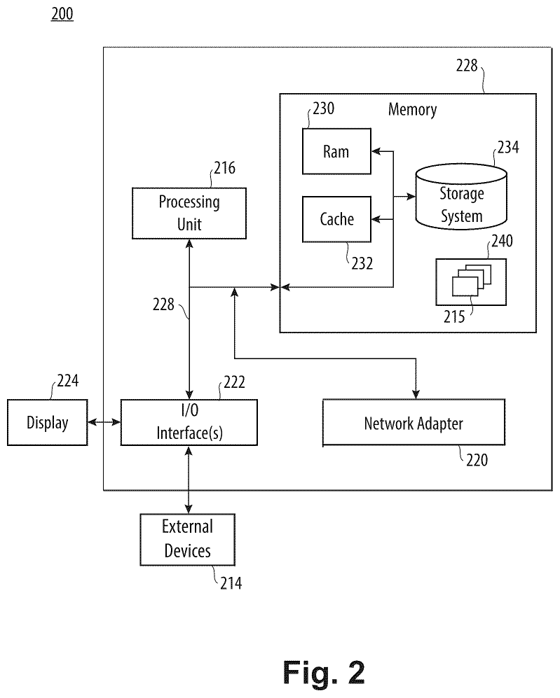

FIG. 2 is a schematic block diagram of an example network computing device 200 (e.g., client computing device 103, server 106, etc.) that may be used (or components thereof) with one or more embodiments described herein (e.g., as one of the nodes shown in the network 100) for identifying data anomalies in time-based metric data (e.g., CPU metric data) through implementation of mathematical modeling and machine learning techniques. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, particularly identifying early warning indicators of significant issues associated with anomalies present in time-based metric data (e.g., CPU metric data) associated with computer devices (e.g., computer servers), via mathematical modeling and machine learning techniques. These indicators trigger/enable implementation of proactive remediation to either avoid impact entirely or significantly reducing the time to root cause identification and resolution.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network 100. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments such as identifying and flagging unusual data patterns, or outliers, in seasonal or variable data streams in computer devices (e.g., computer servers), for detecting data anomalies in computer devices preferably utilizing machine learning techniques, as described herein.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein for detecting one or more anomalies in one or more networked computer devices (e.g., 103, 106).

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with Machine Learning/Artificial Intelligence (AI) techniques for determining certain variations in time-based metric data (e.g., CPU data) to detect anomaly conditions in computer devices (e.g., computer server devices 106) as described below in accordance with the illustrated embodiments. The computer system 200 is preferably integrated with an AI system (as also described below) that is preferably coupled to a plurality of external databases/data sources that implements machine learning and artificial intelligence algorithms in accordance with the illustrated embodiments. For instance, the AI system may include two subsystems: a first sub-system that learns from historical data; and a second subsystem to identify and recommend one or more parameters or approaches based on the learning for detecting anomaly events in computer devices. It should be appreciated that although the AI system may be described as two distinct subsystems, the AI system can also be implemented as a single system incorporating the functions and features described with respect to both subsystems.

In accordance with the illustrated embodiments described herein, artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task (e.g., detecting data anomalies) through a steady experience with the certain task.

Also in accordance with the illustrated embodiments, a neural network (NN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network preferably includes an input layer, an output layer, and one or more hidden layers. Each layer includes one or more neurons, and the artificial neural network may include a synapse that links neurons to neurons. In the artificial neural network, each neuron may output the function value of the activation function for input signals, weights, and deflections input through the synapse. For instance, as described in accordance with the illustrated embodiments, the NN may consist of Recurrent Convolutional Neural network for which is trained to learn the visual ‘shapes’ of typical time-based metric data (e.g. CPU data) behavior.

It is to be understood and appreciated that model parameters refer to parameters determined through learning and include a weight value of synaptic connection and deflection of neurons. A hyperparameter means a parameter to be set in the machine learning algorithm before learning, and typically includes a learning rate, a repetition number, a mini batch size, and an initialization function. The purpose of the learning of the neural network may be to determine the model parameters that minimize a loss function. The loss function may be used as an index to determine optimal model parameters in the learning process of the neural network. Machine learning may be classified into supervised learning, unsupervised learning, and reinforcement learning according to a learning method. The supervised learning may refer to a method of learning a neural network in a state in which a label for learning data is given, and the label may mean the correct answer (or result value) that the neural network must infer when the learning data is input to the artificial neural network. The unsupervised learning may refer to a method of learning a neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among neural networks, is also referred to as deep learning, and the deep learning is part of machine learning.

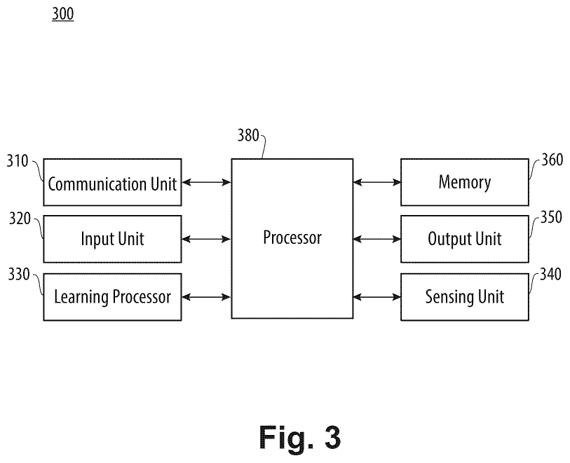

FIG. 3 illustrates an Artificial Intelligence (AI) monitoring device 300 according to an embodiment of the illustrated embodiments. The AI monitoring device 300 may be implemented by a stationary device or a mobile device, such as a web server, a desktop computer, a notebook, a desktop computer, and the like.

Referring to now FIG. 3, and in conjunction with FIGS. 1 and 2, the AI monitoring device 300 is operatively coupled to, or integrated with computing device 200, in accordance with the illustrated embodiments described herein. AI monitoring device 300 preferably includes a communication unit 310, an input unit 320, a learning processor 330, a sensing unit 340, an output unit 350, a memory 360, and a processor 380. The communication unit 310 may transmit and receive data to and from external devices, such as other AI devices, by using wire/wireless communication technology. For example, the communication unit 310 may transmit and receive time-based metric data (e.g., CPU data), a user input, a learning model, and a control signal to and from external devices, such as AI server 400.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of data, including, but not limited to time-based metric data (e.g., CPU data). The input unit 320 may acquire a learning data for model learning (e.g., learning the ‘shapes’ of typical time-based metric data (e.g. CPU data) behavior) and input data (e.g., near real-time metric data) to be used when an output is acquired by using a learning model. The input unit 320 may acquire raw input data. In this case, the processor 380 or the learning processor 330 may extract an input feature by preprocessing the input data. The learning processor 330 may learn a model composed of an neural network by using learning data. The learned neural network may be referred to as a learning model. The learning model may be used to an infer result value for new input data rather than learning data, and the inferred value may be used as a basis for determination to perform a certain operation.

At this time, the learning processor 330 may perform AI processing together with the learning processor 440 of the AI server 400, and the learning processor 330 may include a memory integrated or implemented in the AI monitoring device 300. Alternatively, the learning processor 330 may be implemented by using the memory 360, an external memory directly connected to the AI monitoring device 300, or a memory held in an external device.

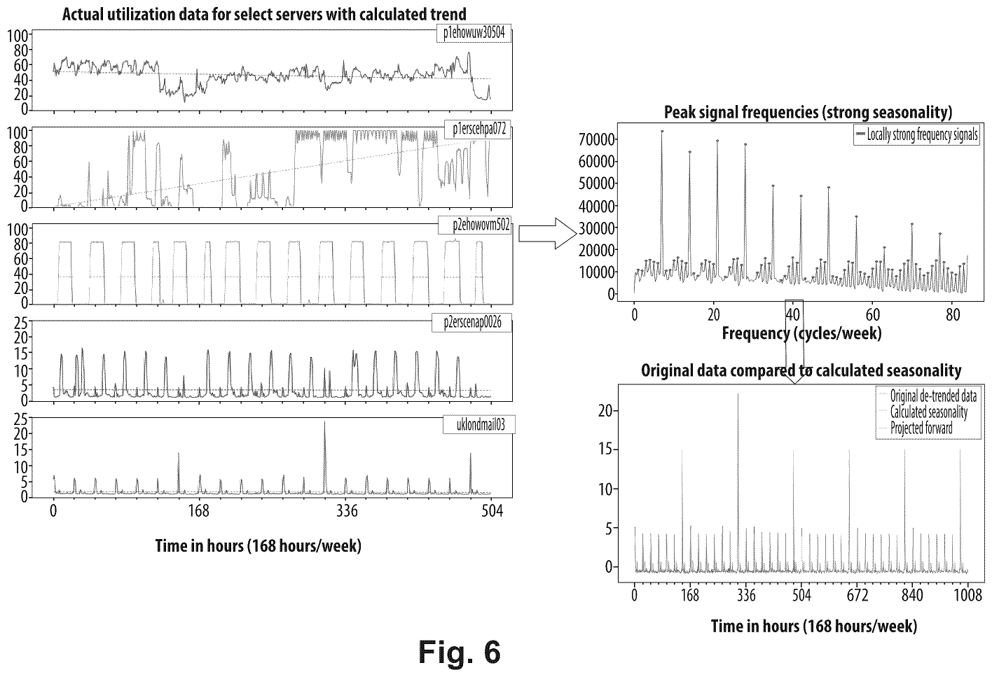

The output unit 350 preferably includes a display unit for outputting/displaying relevant information to a user in accordance with the illustrated embodiments described herein (e.g., FIGS. 6-8). The memory 360 preferably stores data that supports various functions of the AI monitoring device 300. For example, the memory 360 may store input data acquired by the input unit 320, learning data, a learning model, a learning history, and the like.

The processor 380 preferably determines at least one executable operation of the AI monitoring device 300 based on information determined or generated by using a data analysis algorithm or a machine learning algorithm (e.g., linear regression, SARIMA, Fast Fourier Transformation, etc.). The processor 380 may control the components of the AI monitoring device 300 to execute the determined operation. To this end, the processor 380 may request, search, receive, or utilize time-based metric data of the learning processor 330 or the memory 360. The processor 380 may control the components of the AI monitoring device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. In some embodiments, the processor 380 may acquire the intention information corresponding to the user input by using at least one of a speech to text (STT) engine for converting speech input into a text string or a natural language processing (NLP) engine for acquiring intention information of a natural language. At least one of the STT engine or the NLP engine may be configured as an artificial neural network, at least part of which is learned according to the machine learning algorithm. At least one of the STT engine or the NLP engine may be learned by the learning processor 330, may be learned by the learning processor 340 of the AI server 400, or may be learned by their distributed processing. The processor 380 may collect history information including the operation contents of the AI monitoring device 300 or the user's feedback on the operation and may store the collected history information in the memory 360 or the learning processor 330 or transmit the collected history information to the external device such as the AI server 400. The collected history information may be used to update the learning model.

The processor 380 may control at least part of the components of AI monitoring device 300 so as to drive an application program stored in memory 360. Furthermore, the processor 380 may operate two or more of the components included in the AI monitoring device 300 in combination so as to drive the application program.

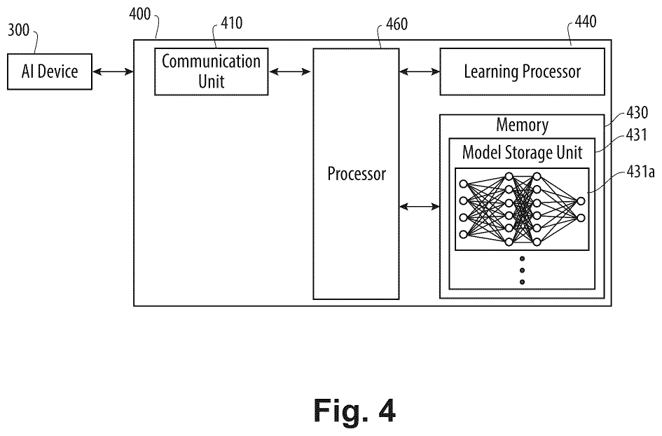

FIG. 4 illustrates an AI server 400 according to the illustrated embodiments. It is to be appreciated that the AI server 400 may refer to a device that learns an artificial neural network by using a machine learning algorithm or uses a learned artificial neural network. The AI server 400 may include a plurality of servers to perform distributed processing, or may be defined as a 5G network. At this time, the AI server 400 may be included as a partial configuration of the AI monitoring device 300, and may perform at least part of the AI processing together. The AI server 400 may include a communication unit 410, a memory 430, a learning processor 440, a processor 460, and the like. The communication unit 410 can transmit and receive data to and from an external device such as the AI monitoring device 300. The memory 430 may include a model storage unit 431. The model storage unit 431 may store a learning or learned model (or an neural network 431a) through the learning processor 440.

The learning processor 440 may learn the artificial neural network 431a by using the learning data. The learning model may be used in a state of being mounted on the AI server 400 of the neural network or may be used in a state of being mounted on an external device such as the AI monitoring device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

With the exemplary communication network 100 (FIG. 1), computing device 200 (FIG. 2), AI monitoring device 300 (FIG. 3) and AI server 400 (FIG. 4) being generally shown and discussed above, description of certain illustrated embodiments will now be provided. It is to be understood and appreciated that exemplary embodiments implementing one or more components of FIGS. 1-4 relate to an Artificial Intelligence (AI) based computer system and method for determining anomalies in time-based metric data. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

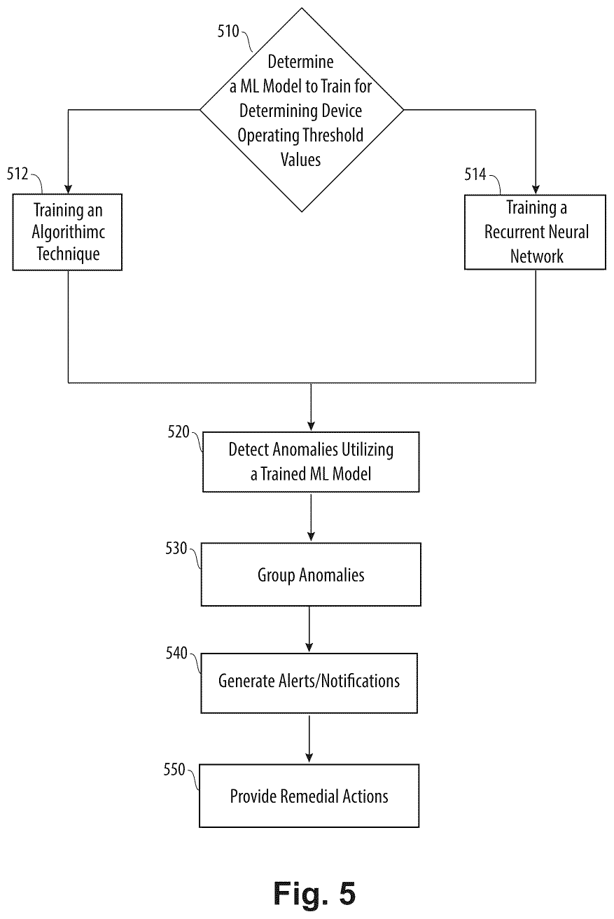

With the exemplary communication network 100 (FIG. 1), computing device 200 (FIG. 2), AI monitoring device 300 (FIG. 3) and AI server 400 (FIG. 4) being generally shown and discussed above, description of certain illustrated embodiments will now be provided. With reference now to the illustrated embodiment of FIG. 5, shown is an exemplary process for detecting one or more anomaly conditions in one or more computer devices (e.g., computing devices 103, and servers 106) utilizing mathematical modeling and machine learning techniques. It is to be appreciated that while the illustrated embodiment may be described relative to detecting anomalies in CPU data of a computer server 106, the illustrated embodiment is not to be understood to be limited thereto, as it is applicable to detecting anomalies in various physical or virtual entity devices (e.g., computer devices, systems and networks) from which a particular metric can be collected over time (time-based metric data) (e.g, detecting anomalies in organic data, such as in electrocardiogram (EKG) data).

Starting at step 510, AI monitoring device 300 preferably trains a machine learning (ML) model for a computer server 106 to determine threshold operating values for CPU data associated with the computer server 106. For training the ML model, preferably a historical backlog of data (e.g., three (3) weeks) is collected on a per-metric, per-device for all devices (e.g., 103, 106) and then sent to the AI monitoring device 300 (which preferably includes a data warehouse 360). Preferably, the aforesaid data is collected on a timed periodic basis, such as a per-hour basis. For ease of description, the illustrated embodiment is to be described relative to collecting data on an hourly periodic basis. However, the illustrated embodiments are not to be understood to be limited thereto as other time periods for collecting historical data may be utilized for training the aforesaid AI model, such as thirty (30) minute increments, 2-hour increments, and the like. Preferably, for each hour of historical metric data collected for computer server 106, leveraged are the average value of that data metric from that hour from that server 106, preferably accompanied by the measured standard deviation of that metric data during that hourly period. Afterwards, the collected data structures are preferably cleansed, and chronologically missing values are preferably imputed where feasible.

In accordance with the illustrated embodiments, it is to be understood and appreciated that both the hourly-aggregated historical average and standard deviation metric data sets are modeled using a plurality of modeling techniques. For ease of description, the AI monitoring device 300 of the illustrated embodiment models the collected CPU data of server 106 using three different modeling techniques (but is not to be understood to be limited thereto), namely: 1) a linear regression algorithm (e.g., via an available library, “scikit-learn”); 2) a Fast Fourier Transform (FFT) algorithm (e.g., via an available library, “SciPy”); and 3) a Seasonal Autoregressive Integrated Moving Average (SARIMA) algorithm (e.g., via an available library, “Statsforecast”). As understood by one skilled in the art, a linear regression algorithm is a supervised machine learning algorithm that predicts the outcome of an event based on independent variable data points, a SARIMA algorithm a statistical technique used to forecast time series data, and a FFT algorithm is a “divide and conquer” algorithm that calculates the Discrete Fourier Transform (DFT) of an input, often used when a signal needs to be processed in the spectral or frequency domain.

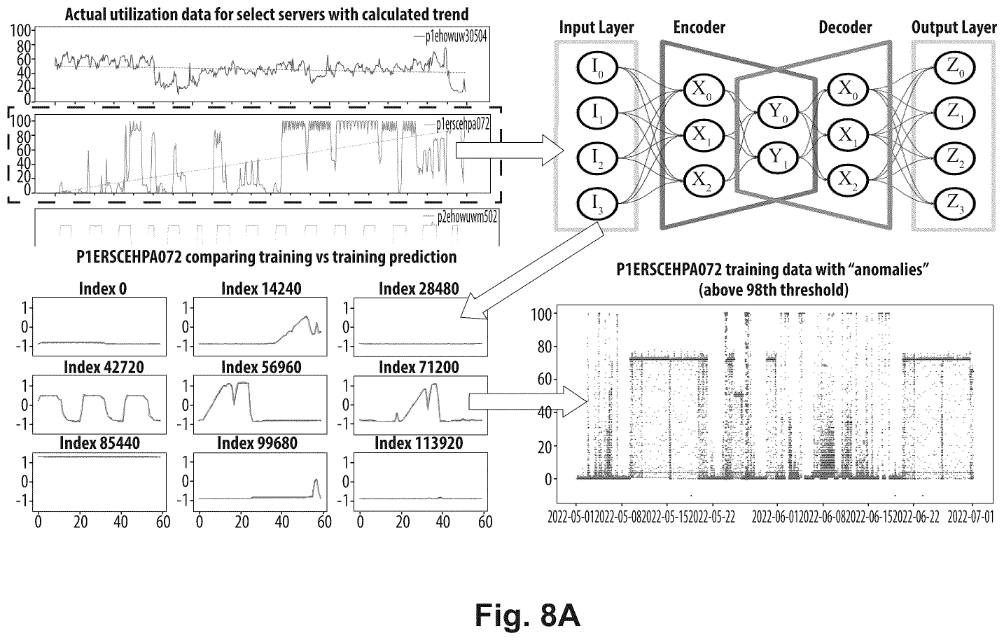

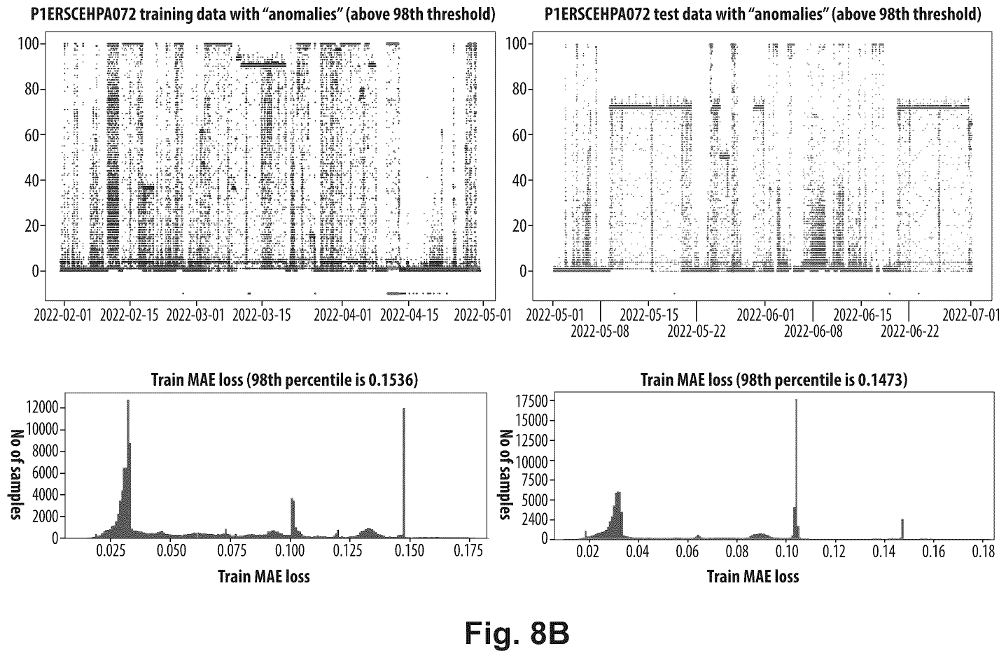

Preferably, and as shown in FIG. 6, for each monitored device 106, and for its associated time-based metric data (e.g., CPU data), the AI monitoring device 300 determines which aforesaid algorithm is most suitable for a particular device 106 and its time-based metric data, preferably contingent upon the error rate of each algorithm's predictions as compared to the aforesaid historical data utilized for the modeling threshold operating values for time-based metric data (e.g., CPU data) associated with the computer server 106 (step 512). However, in accordance with the illustrated embodiments, while often one of the aforesaid predictive algorithmic techniques (e.g., linear regression, SARIMA and FFT) will be found suitable for use with the data metrics of a particular device 106, there are scenarios in which certain data metrics of certain devices 106 may exhibit error levels exceeding a prescribed (e.g., suitable) threshold value (which is preferably calibrated via aggregate analysis of the overall error sets). Hence, none of the aforesaid predictive algorithmic techniques will be determined suitable for use by AI monitoring device 300 as the modeling algorithm for threshold operating values for CPU data associated with the computer server 106, thus bypassing step 512. In this scenario, (e.g., a device metric data stream cannot be modeled via any of the above algorithms to a sufficient level —i.e., is not sufficiently predictable), the AI monitoring device 300 preferably utilizes a separate recurrent convolutional neural network model (e.g., an “Autoencoder”) for modelling the collected historical data from a device 106 to determine a threshold operating condition for that device 106, as further described below with regard to step 514, and with reference to FIGS. 8A and 8B. As is known to one skilled in the art, convolutional recurrent neural networks (CRNNs) are a combination of convolutional neural networks (CNNs) and recurrent neural networks (RNNs) that are preferably for processing images (e.g., images of CPU data). The Autoencoder preferably utilizes transformers, such TensorFlow and Keras, and has specific layers in its neural network (e.g., 431a). For instance, FIG. 8B graphically illustrates the training of a Recurrent Convolutional Neural Network (RCNN) (“Autoencoder”). For example, the layers (431a) may consist of (in sequence) a 1-D convolutional layer, a dropout layer, a second convolutional layer, a 1-D convolutional transpose layer, a second dropout layer, and two more 1-D convolutional transpose layers. In accordance with the illustrated embodiments, a ‘scaled exponential linear unit’ was utilized for the activation functions for the inner layers of the neural network (431a).

Returning to the scenario in which the AI monitoring device 300 determines one of the aforesaid applied algorithmic techniques is determined suitable, and determines which aforesaid algorithm (e.g., the linear regression algorithm) is most suitable for a particular device 106 and its data metrics as the trained ML model for determining threshold operating values for CPU data associated with the computer server 106 (step 512), preferably timed periodic (e.g., hourly) future predictions for average and standard deviation for each server 106 are fed into a Beta distribution to generate periodic (e.g., hourly) confidence intervals which determine lower and upper operating thresholds for each device 106, for each timed period (e.g., hour), as shown in

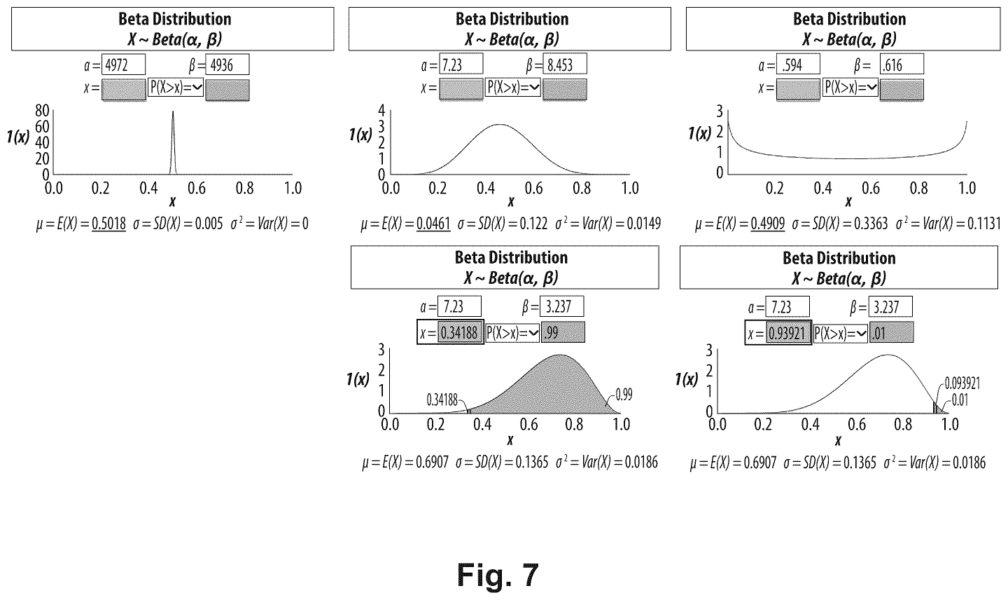

FIG. 7. At step 520, near real-time data points from these devices 106 are then compared to the per-hour, per-server thresholds determined in step 512, and any data point that falls outside of the predicted thresholds (i.e., above the upper threshold or below the lower threshold) is recorded as an anomaly, which may in turn be aggregated for that device/application 106, as described below in step 530.

Returning to the scenario in which the AI monitoring device 300 determines none of the aforesaid applied algorithmic techniques is determined suitable (step 510) whereby an Autoencoder is applied as the trained ML model for modelling the collected historical data from a device 106 to determine its threshold operating condition (step 514), preferably for each individual device data metric stream which is not sufficiently predictable by linear or seasonal forecasting, a periodic timed period (e.g., three (3) months) of raw data points, preferably at 1data point per minute (e.g., that is a series of approximately 130,000 data points) are used to train an Autoencoder on the ‘shapes’ in each CPU metric data stream per server device 106. In accordance with the illustrated embodiments, rolling one-hour windows of raw historical data points associated with the device 106 are fed into the recurrent convolutional neural network (Autoencoder) which is trained to learn the ‘shapes’ of typical metric (e.g. CPU) behavior by forcing the output of the Autoencoder to match the input (each given one-hour window of raw data points) (step 514).

After training the Autoencoder (step 514), next at step 520, preferably near real-time metric data associated with a device 106 are fed into the trained Autoencoder for the associated device metric stream, and when the output is “sufficiently different” from the input (e.g., the input has “noise” (i.e. the input ‘shape’ differs from the training data)) this implies that that block of input contains one or more anomalies. In accordance with the illustrated embodiments, “sufficiently different” thresholds are calculated on a per-device per-metric-stream basis based on the statistical distributions of error when the trained models are run against historical ‘test’ data for each device metric stream.

Thus, as described above, in the scenario an algorithmic technique is utilized as the trained ML model (step 512), individual anomalies in metric streams are collected by comparing real-time data to hourly predicted confidence intervals. Alternatively, if an Autoencoder is utilized as the trained ML model (step 514), individual anomalies in metric streams are collected by feeding real-time data into a trained autoencoder for that stream so as detect when the Autoencoder output exhibits evidence of “noise” /anomalies.

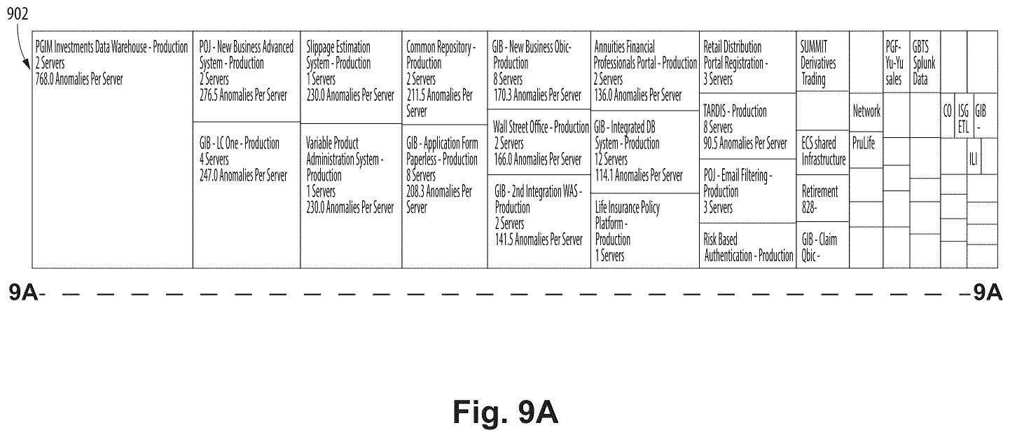

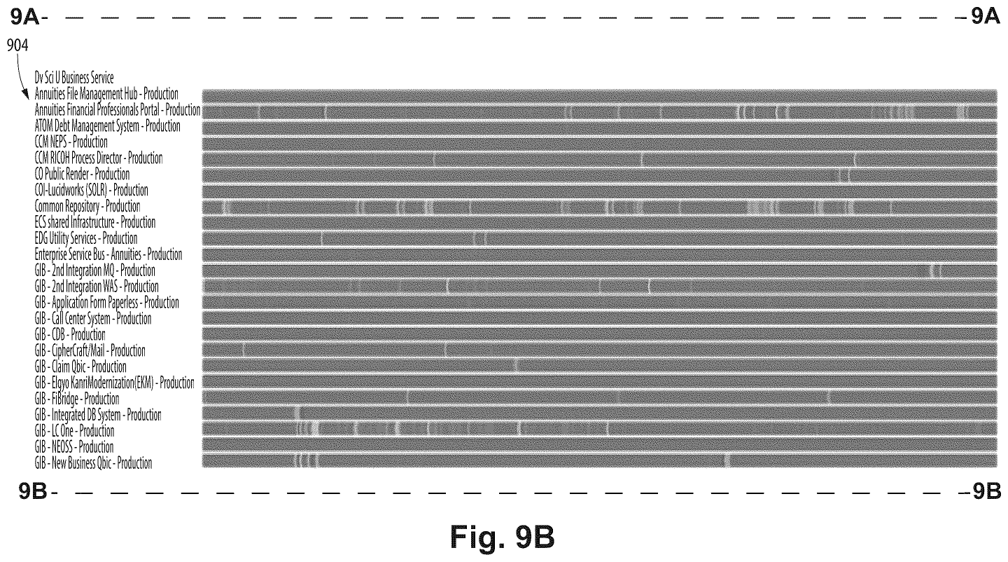

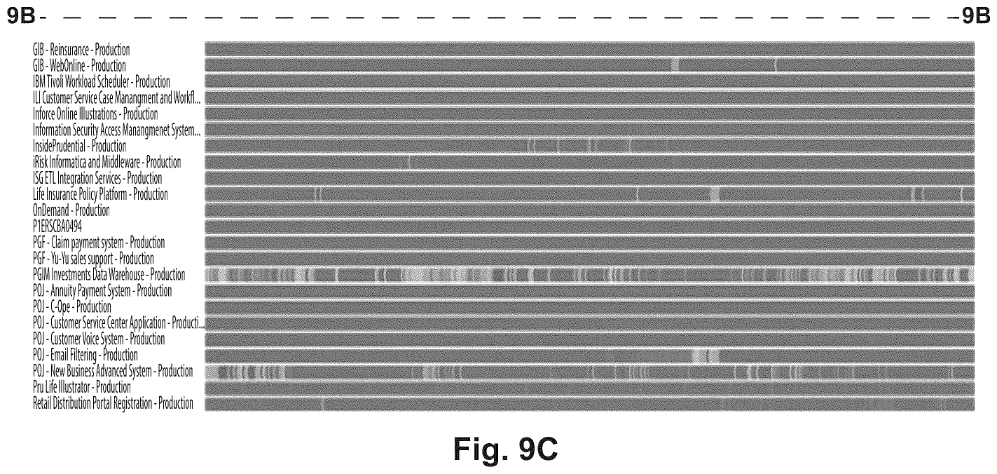

Next, at step 530, the AI monitoring device 300, utilizing its implemented ML model for certain metric data associated with a certain device 106 (as described above in steps 510, 512 and 514), and preferably utilizing its trained Anomaly Detection ML model, organizes the collected anomalies by device 103, 106 and/or related business applications associated with those devices 103, 106. It is to be appreciated that devices 103, 106 and associated metric data streams are typically related to business services on a many-to-many basis, which are typically stored in a configuration management database (CMDB). For instance, for each business service operating with on a business enterprise network 100, the AI monitoring device 300 preferably calculates the total anomalies found for all the devices 106 and metrics associated with that business service for a prescribed interval of time (e.g., 5-min intervals). For instance, as shown in FIG. 9, the AI monitor device 300 in certain embodiments generates a dashboard type display 900 on a computer device accessible to a user that graphically illustrates the aforesaid detected anomalies (step 520). In the illustrated embodiment of FIG. 9, a first section 902 of the display 900 illustrates detected anomalies grouped by a device type (e.g., a server), and a second section of the display 900 illustrates detected anomalies correlated to a related service (e.g., a business service).

Additionally, an alert is preferably generated when the anomaly count, aggregated by a business application/service, exceeds a prescribed baseline level for that application/service by a statistically significant value (step 540). Hence, when an anomaly alert is generated, an incident record is preferably generated, whereby an application support team may be engaged to take one or more remedial actions regarding the anomaly alert (step 550). For instance, in some illustrated embodiments, when either a total anomalies for a recent ‘lookback’ period (e.g., 15 minutes) is statistically significantly higher than expected from the baseline values associated with a device 106, or the “rate of change” of anomaly totals for the most recent intervals indicates movement rapidly higher in a statistically significant way, the AI monitoring system 300 may preferably open a ‘ticket’ for the immediate attention of designated personal so as to effectuate one or more remedial actions associated with the detected anomalies. Alternatively, the AI monitoring system 300 may be configured and operative to automatically effectuate one or more remedial actions upon determination of one or more anomalies (step 520) having a severity level to trigger one or more remedial actions.

With the certain illustrated embodiments described above, noted certain advantages over know prior art techniques for detecting one or more anomalies in one or more computer devices include detecting when CPU utilization of a computer device (e.g., 103, 106) is abnormally low, which is not currently capable in known existing anomaly detection systems.

Other advantages include since the AI models utilized (e.g., steps 512, 514) are lightweight and readily adaptable for implementation with existing business applications, many business applications will benefit from the AI monitoring (e.g., process 500) described above in accordance with the illustrated embodiments. For instance, by mathematically modeling server behavior, the anomaly detection AI/ML model of process 500 has been demonstrated to detect problems anywhere from 40 minutes to 4 days before IT teams were engaged via other tools and manual reporting. Accordingly, beneficiaries of this AI/ML model will encompass a Network Operations Center (OCC), Application Development, Operations, and Application

Owners, as they will be notified of potential business impact faster than with previous monitoring tools, and will experience less disruption in applications. Exemplary use scenarios of the illustrated embodiments include: detecting unusual behavior in system performance metrics to anticipate issues before they impact end-users; identifying patterns that might be missed by a human or traditional monitoring tools, for instance, detecting cold CPU utilization during a period which normally has high utilization (e.g., something isn't running that should be); foreseeing storage space exhaustion in a data center and generating timely alerts to avert potential downtimes; and predicting future capacity needs and providing recommendations for optimization, which can facilitate in cost savings by reducing over-provisioning, or in ensuring uptime by adding necessary resources ahead of demand; predicting network bottlenecks or failures, and automatically re-routing traffic via automation platforms; analyzing network telemetry data to improve performance or resolve intermittent connectivity issues before broader impact; proactively identifying security anomalies or potential breaches by analyzing vast amounts of log and event data in real near-time; and enabling data-driven recommendations on hardware or software upgrades based on performance data.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detecting one or more anomaly conditions in at least one computer device, comprising the steps:
training a machine learning (ML) model for the at least one computer device to determine threshold operating values for time-based metric data associated with the at least one computer device;
comparing, for the at least one computer device, utilizing the trained ML model, time-based metric data to the determined threshold operating values to determine if the time-based metric data falls outside of the determined threshold operating values; and
providing notification of an anomaly condition for the at least one computer device responsive to determining the time-based metric data falls outside of the determined threshold operating values associated with the at least one computer device.

2. The computer-implemented method, wherein one or more anomaly conditions are detected for a plurality of computer devices.

3. The computer-implemented method as recited in claim 2, wherein the time-based metric data is CPU metric data.

4. The computer-implemented method as recited in claim 2, wherein training a ML model for the at least on computer devices includes the steps:
applying a plurality of ML algorithmic techniques each being trained utilizing archived time-based metric data for the at least one computer device;
determining an error value for each of the plurality of ML algorithmic techniques utilizing the archived time-based metric data for the at least one computer device;
determining, responsive to utilizing the archived time-based data for the at least one computer device, if a determined error value for one or more of the ML algorithmic techniques is within a prescribed threshold for use;
applying as the trained ML model, responsive to determining one or more the plurality of ML algorithmic techniques has an error within the prescribed threshold for use, the applied ML algorithmic technique having a smallest error value relative to the other applied ML algorithmic techniques;
applying as the trained ML model, responsive to determining none of the applied ML algorithmic techniques has an error within a prescribed threshold for use, a recurrent convolutional neural network for determining the presence of an anomaly condition in time-based metric data associated with the at least computer device.

5. The computer-implemented method as recited in claim 4, wherein the plurality of ML algorithmic techniques includes: 1) a linear algorithm; 2) a Fast Fourier Transform (FFT) algorithm; and 3) a Seasonal Autoregressive Integrated Moving Average (SARIMA) algorithm.

6. The computer-implemented method as recited in claim 5, further including the step, responsive to applying the trained ML model having an applied ML algorithmic technique, inputting future predictions of a certain time period for average and standard deviation for the at least one computer device into a Beta distribution to generate confidence intervals for the certain time period to determine the threshold operating values defined by CPU operating values.

7. The computer-implemented method as recited in claim 4, further including the step: responsive to utilizing the trained recurrent convolutional neural network as the trained ML model for determining an anomaly condition for the at least one computer device, applying archived time-based metric data from the at least one computer device to the recurrent convolutional neural network for training it to learn certain shapes associated with typical CPU metric data behavior associated with the at least one computer device.

8. The computer-implemented method as recited in claim 7, further including the step: responsive to learning certain shapes associated with time-based metric data behavior of the at least one computer device, applying near real-time based metric data from the at least one computer device to the trained recurrent convolutional neural network for determining if the output of the trained recurrent convolutional neural network is different relative to the input time-based metric data to determine an anomaly condition.

9. The computer-implemented method as recited in claim 8, wherein determining if the output of the trained recurrent convolutional neural network is different relative to the input time-based metric data includes determining the output of the trained recurrent convolutional neural network differentiates from the input time-based metric data by a prescribed threshold value.

10. The computer-implemented method as recited in claim 9, wherein the prescribed threshold value is calculated on a per computer device, per-metric-stream basis, contingent upon the statistical distributions of error when trained recurrent convolutional neural networks are executed with archived metric data for each time-based metric data stream for each of a plurality of computer devices.

11. The computer-implemented implemented method as recited in claim 10, wherein rolling one-hour windows of raw historical metric data points associated with the at least computer device is applied to the recurrent convolutional neural network for training it to learn the certain shapes of typical metric data behavior associated with the at least computer device by forcing the output of the trained recurrent convolutional neural network to match the input of the trained recurrent convolutional neural network relative to each given one-hour window of the raw historical time-based metric data points.

12. The computer-implemented method as recited in claim 11, wherein the time-based metric data is CPU metric data associated with a computer server device.

13. The computer-implemented method as recited in claim 4, wherein the recurrent convolutional neural network includes, as transformers, a TensorFlow software library and a Keras application programming interface (API).

14. The computer-implemented method as recited in claim 13, wherein layers of the recurrent convolutional neural network sequentially include a 1-D convolutional layer, a dropout layer, a second convolutional layer, a 1-D convolutional transpose layer, a second dropout layer, and two 1-D convolutional transpose layers.

15. The computer-implemented method as recited in claim 14, wherein inner layers of the recurrent convolutional neural network utilize a scaled exponential linear unit for activation functions for the inner layers.

16. The computer-implemented method as recited in claim 15, wherein specific initialization parameters for each layer of the recurrent convolutional neural network are trained via hyperparameters.

17. The computer-implemented method as recited in claim 1, wherein providing notification of an anomaly condition includes calculating a total number of anomalies determined for the at least one computer device and data metrics associated with a certain business service for a certain interval of time wherein either: 1) the total anomalies for a recent lookback period is statistically significantly higher, or lower, than expected from baseline values; or 2) a rate of change of anomaly totals for a most recent intervals indicates movement rapidly higher in a statistically significant way, whereby a ticket is opened with notification of the open ticket being provided to a designated personal associated with the certain business service for enabling possible remedial action.

18. The computer-implemented method as recited in claim 4, wherein the archived time-based metric data associated with the at least one computer device consists of a historical backlog of CPU metric data collected on a per-metric, per-device, and per-hour basis.

19. The computer-implemented method as recited in claim 18, wherein for each hour of archived CPU metric data, determined is: 1) an average value of that time-based metric data; and 2) a measured standard deviation of the time-based metric data.

20. The computer-implemented method as recited in claim 8, wherein determining if the output of the trained recurrent convolutional neural network is different from the input time-based metric data includes determining if noise associated with the input time-based metric data relative to the trained recurrent convolutional neural network output exceeds a threshold value.

21. A computer-implemented method for detecting one or more anomaly conditions in a plurality of computer devices, comprising the steps:
training a machine learning (ML) model for each of the plurality of computer devices to determine threshold operating values for a CPU for each of the plurality of computer devices, including:
applying a plurality of ML algorithmic techniques each trained utilizing archived CPU metric data for each of the plurality of computer devices;
determining an error value for each of the plurality of ML algorithmic techniques utilizing the archived CPU metric data for each of the plurality of computer devices;
determining, responsive to utilizing the archived CPU metric data for each of the plurality of computer devices, if a determined error value for one or more of the ML algorithmic techniques is within a prescribed threshold for use;
applying as the trained ML model, responsive to determining one or more of the plurality of ML algorithmic techniques has an error within a prescribed threshold for use, the applied ML algorithmic technique having a smallest error value relative to the other applied ML algorithmic techniques;
applying as the trained ML model, responsive to determining none of the applied ML algorithmic techniques has an error within a prescribed threshold for use, a recurrent convolutional neural network (Autoencoder) for determining the presence of an anomaly condition in CPU data associated with one or more of the plurality of computer devices;
comparing, utilizing the trained ML model, determined for each of the plurality computer devices, near real-time CPU metric data to the determined threshold operating values to determine if the near real-time CPU metric data falls outside of the determined threshold operating values indicative of an anomaly condition; and
providing notification of an anomaly condition for one or more of the plurality of computer devices, responsive to determining the CPU metric data falls outside of the determined threshold operating values associated with one or more of the plurality of computer devices.

22. The computer-implemented method as recited in claim 21, applying, responsive to utilizing the Autoencoder as the trained ML model for determining an anomaly condition for one or more of the plurality of computer devices, archived CPU metric data from one or more of the computer devices to the recurrent convolutional neural network for training it to learn certain shapes associated with typical CPU metric data behavior associated with one or more of the plurality of computer devices.

23. The computer-implemented method as recited in claim 22, applying, responsive to learning certain shapes associated with typical CPU metric data behavior of one or more of the plurality of computer devices, near real-time CPU metric data from one or more of the plurality of computer devices to the Autoencoder to determine if the output of the Autoencoder is different relative to the input time-based metric data, which is indicative of an anomaly condition for one or more of the plurality of computer devices.

24. The computer-implemented method as recited in claim 23, wherein determining if the output of the Autoencoder is different from the input time-based metric data includes determining if noise associated with the input time-based metric data relative to the Autoencoder output exceeds a prescribed threshold value.

25. The computer-implemented method as recited in claim 24, wherein the prescribed threshold value is calculated on a per computer device, per-metric-stream basis, contingent upon the statistical distributions of error when trained Autoencoders are executed with archived metric data for each CPU metric data stream for each of the plurality of computer devices.

26. The computer-implemented method as recited in claim 23, further including the steps:
grouping identified anomalies associated with a certain computer device from the plurality of computer devices;
determining when a count value of identified grouped anomalies exceeds a prescribed value for the certain computer device; and
providing notification of the identified anomaly to a user when it is determined the count value exceeds the prescribed value.

27. A computer system for detecting one or more anomaly conditions in one or more computer devices, comprising the steps:
one or more storage devices having instructions stored thereon that, when executed by one or more processors, cause the one or more processors to:
train a machine learning (ML) model for at least one computer device to determine threshold operating values for time-based metric data associated with the one or more computer devices;
comparing, for at least one computer device, utilizing the trained ML model, time-based metric data to the determined threshold operating values to determine if the time-based metric data falls outside of the determined threshold operating values; and
providing notification of an anomaly condition for a computer device responsive to determining the time-based metric data falls outside of the determined threshold operating values associated with the at least one computer device.

28. The computer system as recited in claim 27, wherein training a ML model for the one or more computer devices, includes the steps:
applying a plurality of ML algorithmic techniques each being trained utilizing archived time-based metric data for the one or more computer devices;
determining an error value for each of the plurality of ML algorithmic techniques utilizing the archived time-based metric data for the one or more computer devices;
determining, responsive to utilizing the archived time-based data for the one or more computer devices, if a determined error value for one or more of the ML algorithmic techniques is within a prescribed threshold for use;
applying as the trained ML model, responsive to determining one or more of the plurality of ML algorithmic techniques has an error within a prescribed threshold for use, the applied ML algorithmic technique having a smallest error value relative to the other applied ML algorithmic techniques; and
applying as the trained ML model, responsive to determining none of the applied ML algorithmic techniques has an error within a prescribed threshold for use, a recurrent convolutional neural network for determining the presence of an anomaly condition in time-based metric data associated with one or more computer devices.

29. The computer system as recited in claim 28, wherein the plurality of ML algorithmic techniques includes: 1) a linear algorithm; 2) a Fast Fourier Transform (FFT) algorithm; and 3) a Seasonal Autoregressive Integrated Moving Average (SARIMA) algorithm.

30. The computer system as recited in claim 29, wherein the processor is further configured to, responsive to applying the trained ML model having an applied ML algorithmic technique, inputting future predictions of a certain time period for average and standard deviation for the one or more computer devices into a Beta distribution to generate confidence intervals for the certain time period to determine the threshold operating values defined by CPU operating values.

31. The computer system as recited in claim 30, wherein the processor is further configured to, responsive to utilizing the trained recurrent convolutional neural network as the trained ML model for determining an anomaly condition for the one or more computer devices, applying archived time-based metric data from the one or more computer devices to the recurrent convolutional neural network for training it to learn certain shapes associated with typical CPU metric data behavior associated with the one or more computer devices.
